(19) United States
(12) Patent Application Publication
(10) Pub. No.: US 2007/0125831 A1
(43) Pub. Date: Jun. 7, 2007

(54) CAPILLARY FOR A BONDING TOOL

(76) Inventors: Srikanth NARASIMALU, Singapore (SG); Ning YING, Singapore (SG); Loon Aik LIM, Singapore (SG)

Correspondence Address: OSTROLENK FABER GERB & SOFFEN, 1180 AVENUE OF THE AMERICAS, NEW YORK, NY, 100368403, US

(21) Appl. No.: 11/567,331

(22) Filed: Dec. 6, 2006

Related U.S. Application Data
(60) Provisional application No. 60/742,942, filed on Dec. 6, 2005.

(51) Int. Cl. A47J 36/02

(52) U.S. Cl. 228/101

(57) ABSTRACT

A capillary is provided for a wire bonding tool that comprises a holding portion for clamping the capillary, a conical portion at a tip of the capillary for performing bonding and a substantially frustoconical portion located between the holding portion and the conical portion. The sidewalls of the frustoconical portion form an interfacial angle that is smaller than an interfacial angle formed by the sidewalls of the conical portion so as to provide a gentle taper from the holding portion to the conical portion.

### CROSS REFERENCE TO RELATED APPLICATION

This application claims the benefit and priority of U.S. Provisional Application Ser. No. 60/742,942 filed on Dec. 6, 2005, and entitled CAPILLARY FOR A BONDING TOOL, the disclosure of which is incorporated herein by reference.

### FIELD OF THE INVENTION

The invention relates to a capillary for delivering and bonding a wire, and in particular to a capillary for use in bonding a wire to a device by the application of ultrasonic energy.

### BACKGROUND AND PRIOR ART

During the packaging of the semiconductor devices, it is typically necessary to place a semiconductor chip or integrated circuit die onto a substrate such as a leadframe, and then electrically connect the bonding pads of the die and substrate with conductive bonding wires. Typically, gold, aluminum or copper wires are used to make the connections and carry current between the die and the substrate. When gold or copper wires are used, a ball-bonding process is used, wherein a ball bond is formed at a first bonding point and a stitch bond is formed at a second bonding point.

In the ball-bonding process, the bonding wire used to make the electrical connections is fed through a capillary that is usually manufactured with a ceramic material. An isometric view of a conventional capillary 10 is shown in FIG. 1, which has a straight shank and a bottleneck taper at the end. The capillary 10 comprises a holding portion 12, a flexing portion 14 and a bonding tip 16. Wire is fed from the top of the capillary 10 to the bonding tip 16 through a capillary hole 18. When ultrasonic energy is applied to oscillate a transducer horn (not shown) clamping the capillary 10, the flexing portion 14 will flex according to the oscillation direction of the horn.

The holding portion 12 and a first section of the flexing portion 14 are formed with a cylindrical shape with parallel walls. It is capable of achieving an amplification of 3.8 times the vibration amplitude of the transducer horn that is clamping it. It would be desirable to significantly increase the amplification capability inherent in the capillary 10, such as by up to 12 times the vibration amplitude of the transducer horn.

Another prior art capillary is described in U.S. Pat. No. 6,523,733 entitled “Controlled Attenuation Capillary”, which changes the geometry of the capillary to modify energy to a ball/wire interconnection pad interfacial area, in order to control ultrasonic attenuation of the capillary. This is done by varying the mass distribution along the length of the capillary so that less ultrasonic energy is required to form a bond as compared to conventional capillaries. However, the mass distribution is varied by introducing a transition area with a sharp taper between an upper cylindrical body portion and a lower cylindrical body portion of the capillary. This leads to a sudden and significant change in the cross-sectional areas of the upper and lower cylindrical body portions. Consequently, a high amount of stress is concentrated in the transition area, and reduces the efficiency of bonding energy transfer to the tip of the capillary. The risk of breakage of the capillary at the transition area is also more likely. Furthermore, one embodiment of the invention describes the transition area having a bevel shape that is only formed on two sides of the capillary. In this case, the importance of aligning the bevel shape to the oscillation direction of the ultrasonic horn provides another technical difficulty to the user.

It would be desirable to provide a capillary wherein the mass of the capillary is distributed for greater efficiency in amplifying the vibration amplitude of the transducer horn at the tip of the capillary.

### SUMMARY OF THE INVENTION

It is thus an object of the invention to seek to provide a capillary for a wire bonding tool which is more efficient in amplifying vibrations transmitted for wire bonding while avoiding some of the aforesaid disadvantages of prior art capillaries.

Accordingly, the invention provides a capillary for a wire bonding tool comprising: a holding portion for clamping the capillary; a conical portion at a tip of the capillary for performing bonding; and a substantially frustoconical portion located between the holding portion and the conical portion; wherein sidewalls of the frustoconical portion form an interfacial angle that is smaller than an interfacial angle formed by sidewalls of the conical portion.

It will be convenient to hereinafter describe the invention in greater detail by reference to the accompanying drawings. The particularity of the drawings and the related description is not to be understood as superseding the generality of the broad identification of the invention as defined by the claims.

### BRIEF DESCRIPTION OF THE DRAWINGS

Examples of capillaries in accordance with the invention that may be for wire bonding will now be described with reference to the accompanying drawings, in which:

FIG. 1 is an isometric view of a prior art capillary; and

FIGS. 2 to 6 are cross-sectional views of capillaries according to five different preferred embodiments of the invention.

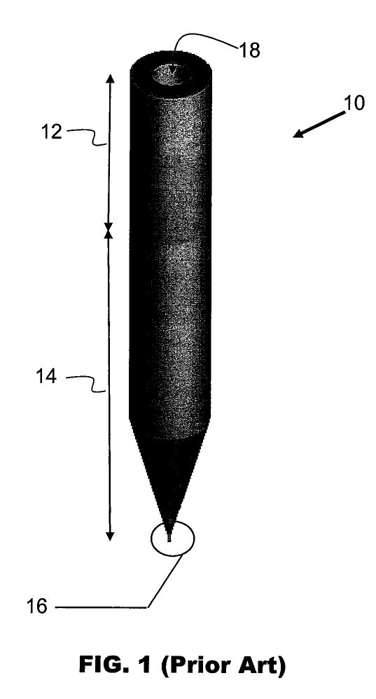

### DETAILED DESCRIPTION OF THE PREFERRED EMBODIMENTS OF THE INVENTION

FIG. 2 is a cross-sectional view of a capillary 20 according to a first preferred embodiment of the invention. Typically, the overall length of the capillary 20 is about 11.10 mm and its diameter at its broadest section is about 1.587 mm. It has a longitudinal axis 22 along its length passing through the center of the capillary 20. The capillary 22 generally comprises a first cylindrical portion 24 which is a holding portion where the capillary 20 is clamped, a conical portion 28 at the tip of the capillary 20, and a substantially frustoconical portion 26 located between the first cylindrical portion 24 and the conical portion 28.

A drawback of prior art capillaries is that they have large cylindrically-shaped sections along the lengths of the capillaries. As a result, any transitions in diameters between different cylindrical capillary sections tend to be rather drastic and introduce relatively large stress concentrations in these transition areas. The preferred embodiments of the invention seek to avoid this drawback by introducing a gentle taper from near a holding portion of the capillary towards its tip.

Thus, a flexible section of the capillary includes a frustoconical portion 26 which has sidewalls that form an interfacial angle that is smaller than an interfacial angle formed by the sidewalls of the conical portion 28. Also, since the shape of the capillary 20 is preferably symmetrical, an angle that a sidewall forms with the longitudinal axis 22 is half of an interfacial angle formed between opposite sidewalls.

More specifically, in this embodiment, the sidewalls of the conical portion 28 form an interfacial angle θ₁ of 20° with respect to each other, and therefore each sidewall forms an angle of 10° with respect to the longitudinal axis 22. The sidewalls of the frustoconical portion 26 form an interfacial angle θ₂ of 6.8° with respect to each other, and therefore each sidewall forms an angle of 3.4° with respect to the longitudinal axis 22. The length L₁ from the top end of the frustoconical portion 26 to the tip of the capillary 20 is 7.08 mm, while the length L₂ of the conical portion 28 is 2.63 mm.

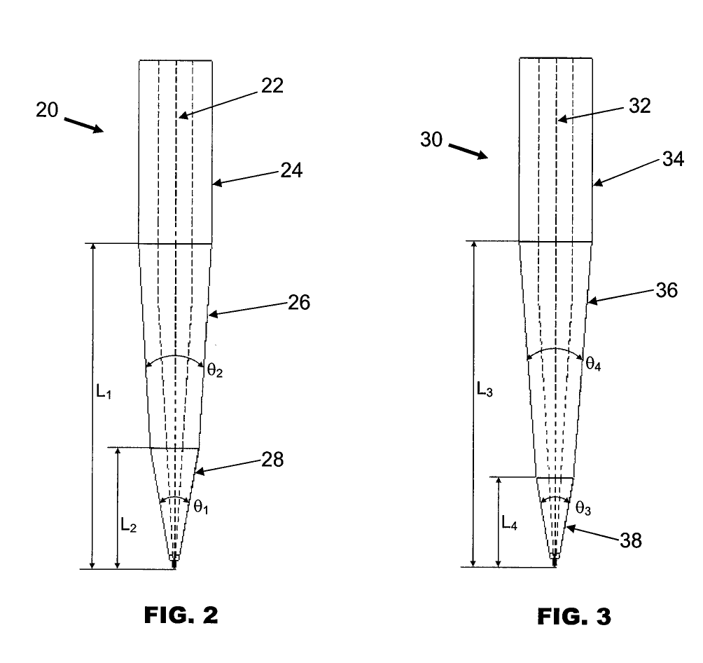

FIG. 3 is a cross-sectional view of a capillary 30 according to a second preferred embodiment of the invention. It has a longitudinal axis 32 along its length passing through the center of the capillary 30. The capillary 30 generally comprises a first cylindrical portion 34, a frustoconical portion 36 and a conical portion 38 at the tip of the capillary 30.

The sidewalls of the conical portion 38 form an angle θ₃ of 20° with respect to each other, and therefore each sidewall forms an angle of 10° with respect to the longitudinal axis 32. The sidewalls of the frustoconical portion 36 form an interfacial angle θ₄ of 8.6° with respect to each other, and therefore each sidewall forms an angle of 4.3° with respect to the longitudinal axis 32. The length L₃ from the top end of the frustoconical portion 36 to the tip of the capillary 30 is the same as the previous embodiment at 7.08 mm. The difference between this embodiment and the embodiment in FIG. 2 is that the length L₄ of the conical portion 38 is 1.92 mm and is shorter as compared to length L₂ of the previous embodiment, which is 2.63 mm. A shorter length of the conical portion allows a more pronounced taper.

Therefore, a longer conical portion 28, 38 leads to a steeper sidewall in the frustoconical portion 26, 36. Accordingly, it is preferred that the height of the conical portion 28, 38 is between 1.92 mm and 2.62 mm, and the sidewalls of the frustoconical portion 26, 36 correspondingly form an interfacial angle of between 6.8° and 8.6°. The choice of the respective dimensions is at the option of the designer.

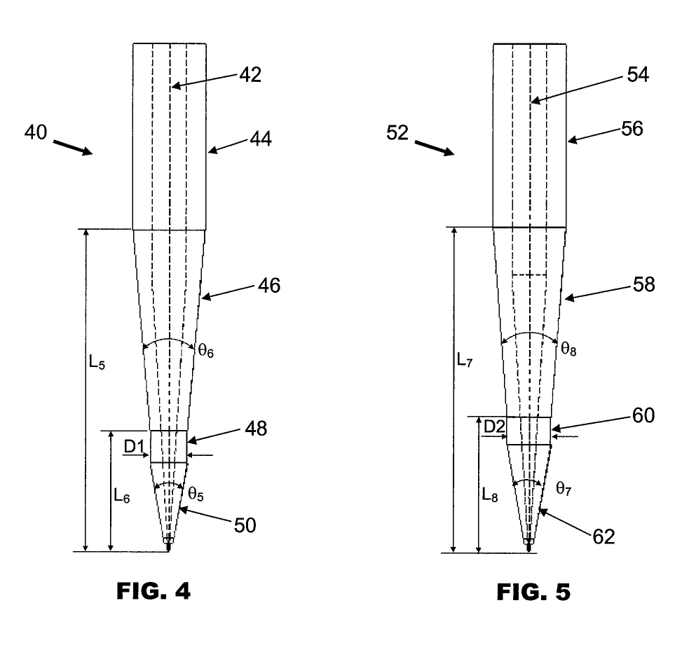

FIG. 4 is a cross-sectional view of a capillary 40 according to a third preferred embodiment of the invention. In this embodiment, the capillary 40 includes a substantially cylindrical intermediate portion between its conical and frustoconical portions. It has a longitudinal axis 42 along its length passing through the center of the capillary 40 and generally comprises a first cylindrical portion 44, a frustoconical portion 46, a substantially cylindrical intermediate portion in the form of a second cylindrical portion 48 and a conical portion 50 at the tip of the capillary 40. A diameter of the second cylindrical portion 48 is equal to the diameters of a base of the frustoconical portion 46 and a top of the conical portion 50 connected to the second cylindrical portion 48.

The sidewalls of the conical portion 50 form an interfacial angle θ₅ of 20° with respect to each other, and therefore each sidewall forms an angle of 10° with respect to the longitudinal axis 42. The sidewalls of the frustoconical portion 46 form an interfacial angle θ₆ of 10° with respect to each other, and therefore each sidewall forms an angle of 5° with respect to the longitudinal axis 42. The diameter D1 of the second cylindrical portion 48 is 0.81 mm. The length L₅ from the top end of the frustoconical portion 46 to the tip of the capillary 40 is 7.08 mm. The total length L₆ of the second cylindrical portion 48 and the conical portion is 2.63 mm.

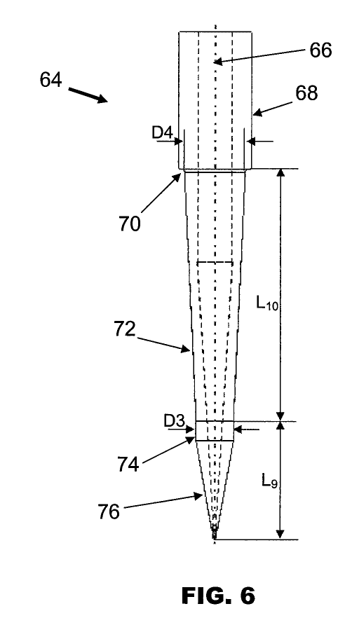

FIG. 5 is a cross-sectional view of a capillary 52 according to a fourth preferred embodiment of the invention. It has a longitudinal axis 54 along its length passing through the center of the capillary 52. The capillary 52 generally comprises a first cylindrical portion 56, a frustoconical portion 58, a second cylindrical portion 60 and a conical portion 62 at the tip of the capillary 20.

The sidewalls of the conical portion 62 form an interfacial angle θ₇ of 20° with respect to each other, and therefore each sidewall forms an angle of 10° with respect to the longitudinal axis 54. The sidewalls of the frustoconical portion 58 form an interfacial angle θ₈ of 8.7° with respect to each other, and therefore each sidewall forms an angle of 4.35° with respect to the longitudinal axis 54. The diameter D2 of the second cylindrical portion 60 is 0.954 mm. The length L₇ from the top end of the frustoconical portion 58 to the tip of the capillary 52 is 7.08 mm. The difference between this embodiment and that in FIG. 4 is that the total length L₈ of the second cylindrical portion 60 and conical portion 62 is 2.93 mm, which is larger than that of the previous embodiment (L₆) at 2.63 mm in FIG. 4.

Given the same lengths L₅, L₇ of the portions of the respective capillaries 40, 52 below the first cylindrical portions 44, 56, the taper in the sidewalls of the frustoconical portion 58 can be made gentler in the fourth preferred embodiment. Therefore, a longer length of the second cylindrical portion 48, 60 and the conical portion 50, 62 leads to a steeper sidewall in the frustoconical portion 46, 58. Accordingly, it is preferred that the total height of the second cylindrical portion 48, 60 and the conical portion 50, 62 is between 2.63 mm and 2.93 mm, and the sidewalls of the frustoconical portion 46, 58 form an interfacial angle of between 8.7° and 10°. Again, the choice of the different dimensions within the said ranges is at the option of the designer.

FIG. 6 is a cross-sectional view of a capillary 64 according to a fifth preferred embodiment of the invention. It has a longitudinal axis 66 along its length passing through the center of the capillary 64. The capillary 64 generally comprises a first cylindrical portion 68, a frustoconical portion 72, a second cylindrical portion 74 and a conical portion 76 at the tip of the capillary 64. However, a diameter of a top of the frustoconical portion 72 is smaller than a diameter of a base of the first cylindrical portion 68 connected to the frustoconical portion 72. There may be an additional intermediate chamfered portion 70 between the first cylindrical portion 68 and the frustoconical portion 72.

The diameter D3 of the second cylindrical portion 74 is 0.82 mm, whereas the diameter D4 of the start of the frustoconical portion 72 connected to the chamfered portion 70 is 1.331 mm. The total length L₉ of the second cylindrical portion 74 and conical portion 76 is 2.58 mm, whereas the total length L₁₀ of the chamfered portion 70 and the frustoconical portion 72 is 5.52 mm. The sidewalls of the frustoconical portion 72 form an angle of 2.7° with respect to the longitudinal axis 66, whereas the sidewalls of the conical portion 76 form an angle of 10° with respect to the longitudinal axis 66.

This embodiment shows that a sharp change in the cross-sectional area of the capillary may also be designed into the capillary 64, together with an optional transitional chamfered portion 70 tapering from the first cylindrical portion 68 to connect the first cylindrical portion 68 and the frustoconical portion 72. This design has the advantage of further reducing the mass of the capillary 64 and may introduce greater amplification. Nevertheless, the chamfered portion 70 is preferably kept to a minimum due to the concentration of stress at this area as explained above.

The capillary 64 preferably has a maximum fracture toughness of 10 MPa.m^{1/2} and strength of 450 MPa, which can resist the induced stress arising from the wire bonding process using the above design. Preferably, the capillary is made of Zirconia (1.25 micron particle size)-doped Alumina with a volume fraction of 12-15%.

It would be appreciated from the above-described embodiments of the invention that the changes in the mass distribution along the lengths of the capillaries, from the holding portions down to the tips of the capillaries are more gradual and consistent than in prior art capillaries. To achieve this, the interfacial angle between the sidewalls of the frustoconical portion should be between 4° and 20°, or in other words, between 2° and 10° with respect to the longitudinal axis. More preferably, the interfacial angle should be between 6.4° and 18.4°. It would also be appreciated that the invention need not necessarily be limited to one frustoconical portion between the holding portion and the conical portion, but there can be two or more segments of frustoconical portions.

Moreover, the taper need not necessarily be consistent throughout the frustoconical portions or the conical portions. The surfaces may thus either be straight or curved along the lengths of the capillaries. Nevertheless, the angles of the sidewalls should substantially be the angles from the base to the top of the sidewalls of the respective portions. The capillaries preferably have consistently circular cross-sections throughout the lengths of the capillaries, so that there are no concerns about their alignment with the oscillation direction of the ultrasonic driver and the transducer horns clamping the capillaries.

The aforesaid designs ensure that the cross-sectional area of the capillary is gradually decreased from the holding area to the tip of the capillary. Accordingly, there is a reduction in the mass of the capillary as compared to conventional designs, and hence it requires less energy to oscillate. The lesser mechanical load also leads to lower overall impedance of the transducer.

In use, it was found that the capillary is more efficient in amplifying vibrations transmitted by the transducer horn. In fact, the oscillatory amplitude could be increased by up to two times or more of that attainable using a conventional capillary of the prior art. Hence, for the same vibration amplitude, these capillaries will consume less power from the transducer than the prior art capillaries. Thus, the capillaries according to the preferred embodiments can deliver the same rubbing motion with reduced power of less than 25% of the usual power used for conventional capillaries. As a result, heating of the transducer can be reduced, thereby also reducing the aging characteristics of the transducer.

In addition, the capillary is easy to manufacture and can be made using traditional powder consolidation-sintering methods. Since these improved designs generally avoid any sharp diameter changes or cutouts, moldability of the smooth taper would be relatively straightforward.

The invention described herein is susceptible to variations, modifications and/or addition other than those specifically described and it is to be understood that the invention includes all such variations, modifications and/or additions which fall within the spirit and scope of the above description.

1. A capillary for a wire bonding tool comprising:
a holding portion for clamping the capillary;
a conical portion at a tip of the capillary for performing bonding; and
a substantially frustoconical portion located between the holding portion and the conical portion;
wherein sidewalls of the frustoconical portion form an interfacial angle that is smaller than an interfacial angle formed by sidewalls of the conical portion.

2. The capillary as claimed in claim 1, further comprising a substantially cylindrical intermediate portion between the frustoconical portion and the conical portion.

3. The capillary as claimed in claim 2, wherein a diameter of the cylindrical intermediate portion is equal to the diameters of a base of the frustoconical portion and a top of the conical portion connected to the cylindrical intermediate portion.

4. The capillary as claimed in claim 2, wherein a total height of the cylindrical intermediate portion and the conical portion is between 2.63 mm and 2.93 mm, and the sidewalls of the frustoconical portion form an interfacial angle of between 8.7° and 10°.

5. The capillary as claimed in claim 1, wherein a diameter of a top of the frustoconical portion is less than a diameter of a base of the holding portion connected to the frustoconical portion.

6. The capillary as claimed in claim 5, further comprising a chamfered portion between the base of the holding portion and the top of the frustoconical portion.

7. The capillary as claimed in claim 1, wherein a height of the conical portion is between 1.92 mm and 2.63 mm, and the sidewalls of the frustoconical portion form an interfacial angle of between 6.8° and 8.6°.

8. The capillary as claimed in claim 1, wherein the sidewalls of the frustoconical portion form an interfacial angle of between 4° and 20°.

9. The capillary as claimed in claim 8, wherein the sidewalls of the frustoconical portion form an interfacial angle of between 6.4° and 18.4°.

10. The capillary as claimed in claim 1, wherein the sidewalls of the frustoconical portion are substantially straight.

11. The capillary as claimed in claim 1, wherein the capillary has a substantially circular cross-section throughout its length.
